(19) United States
(12) Patent Application Publication
(10) Pub. No.: US 2011/0174413 A1
(43) Pub. Date: Jul. 21, 2011

(54) Modification of Polyethylene Pipe to Improve Sag Resistance

(75) Inventors: John Ashbaugh, Houston, TX (US); Brian Cole, Kingwood, TX (US); Gerhard Guenther, Kemah, TX (US)

(73) Assignee: Fina Technology, Inc., Houston, TX (US)

(21) Appl. No.: 12/690,257

(22) Filed: Jan. 20, 2010

(51) Int. Cl. F16L 25/00; C08K 3/20; C08K 5/14; B29D 23/00

(52) U.S. Cl. 138/177; 524/438; 524/394; 428/36.92

(57) ABSTRACT

Methods of forming pipe articles and pipe articles are described herein. The methods generally include providing a bimodal ethylene based polymer, blending the bimodal ethylene based polymer with up to about 50 ppm peroxide to form modified polyethylene and forming the modified polyethylene into a pipe.

### FIELD

Embodiments of the present invention generally relate to articles formed with polyethylene. In particular, embodiments of the present invention generally relate to pipe formed with bimodal polyethylene.

### BACKGROUND

As reflected in the patent literature, propylene polymers have been modified in a variety of applications, such as injection molding, rotomolding, blown film, extrusion and solid state stretching processes, for example, with demonstrated improvements in processing and the resulting article's properties. However, the modification of ethylene polymers (and in particular, the modification of ethylene polymers with peroxide) has generally not demonstrated the desired improvements in processing and formed article properties. In particular, modification of ethylene polymers has not provided the desired improvements in sag resistance for pipe articles. Therefore, a need exists to develop ethylene based polymers and processes of forming polymer articles exhibiting improved processing and article properties.

### SUMMARY

Embodiments of the present invention include methods of forming pipe articles. The methods generally include providing a bimodal ethylene based polymer, blending the bimodal ethylene based polymer with up to about 50 ppm peroxide to form modified polyethylene and forming the modified polyethylene into a pipe.

Embodiments further include pipe articles formed by the methods described herein.

### BRIEF DESCRIPTION OF DRAWINGS

FIG. 1 illustrates zero shear viscosity for selected bimodal polyolefins.

### DETAILED DESCRIPTION

### Introduction and Definitions

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should he given the broadest definition skilled persons in the pertinent art have given that term as reflected in printed publications and issued patents at the time of tiling. Further, unless otherwise specified, all compounds described herein may be substituted or unsubstituted and the listing of compounds includes derivatives thereof.

Further, various ranges and/or numerical limitations may be expressly stated below. It should be recognized that unless stated otherwise, it is intended that endpoints are to be interchangeable. Further, any ranges include iterative ranges of like. magnitude falling within the expressly stated ranges or limitations.

Embodiments of the invention generally include pipe articles exhibiting improved sag resistance.

### Catalyst Systems

Catalyst systems useful for polymerizing olefin monomers include any suitable catalyst system. For example, the catalyst system may include chromium based catalyst systems, single site transition metal catalyst systems including metallocene catalyst systems, Ziegler-Nana catalyst systems or combinations thereof, for example. The catalysts may be activated for subsequent polymerization and may or may not be associated with a support material, for example. A brief discussion of such catalyst systems is included below, but is in no way intended to limit the scope of the invention to such catalysts.

For example, Ziegler-Natta catalyst systems are generally formed from the combination of a metal component (e.g., a catalyst) with one or more additional components, such as a catalyst support, a cocatalyst and/or one or more electron donors, for example.

One or more embodiments of the invention include Ziegler-Natta catalyst systems generally formed by contacting an alkyl magnesium compound with an alcohol to form a magnesium dialkoxide compound and then contacting the magnesium dialkoxide compound with successively stronger chlorinating agents. (See, U.S. Pat. No. 6,734,134 and U.S. Pat. No. 6,174,971, which are incorporated herein by reference.)

### Polymerization Processes

As indicated elsewhere herein, catalyst systems are used to form polyolefin compositions. Once the catalyst system is prepared, as described above and/or as known to one skilled in the art, a variety of processes may be carried out using that composition. The equipment, process conditions, reactants, additives and other materials used in polymerization processes will vary in a given process, depending on the desired composition and properties of the polymer being formed. Such processes may include solution phase, gas phase, slurry phase, bulk phase, high pressure processes or combinations thereof, for example. (See, U.S. Pat. No. 5,525,678; U.S. Pat. No. 6,420,580; U.S. Pat. No. 6,380,328; U.S. Pat. No. 6,359,072; U.S. Pat. No. 6,346,586; U.S. Pat. No. 6,340,730; U.S. Pat. No. 6,339,134; U.S. Pat. No. 6,300,436; U.S. Pat. No. 6,274,684; U.S. Pat. No. 6,271,323; U.S. Pat. No. 6,248,845; U.S. Pat. No. 6,245,868; U.S. Pat. No. 6,245,705; U.S. Pat. No. 6,242,545; U.S. Pat. No. 6,211,105; U.S. Pat. No. 6,207,606; U.S. Pat. No. 6,180,735 and U.S. Pat. No. 6,147,173, which are incorporated by reference herein.)

In certain embodiments, the processes described above generally include polymerizing one or more olefin monomers to form polymers. The olefin monomers may include C₂ to C₃₀ olefin monomers, or C₂ to C₁2 olefin monomers (e.g., ethylene, propylene, butene, pentene, methylpentene, hexene, octene and decene), for example. The monomers may include olelinic unsaturated monomers, C₄ to C₁₈ diolefins, conjugated or nonconjugated dienes, polyenes, vinyl monomers and cyclic olefins, for example. Non-limiting examples of other monomers may include norbornene, nobornadiene, isobutylene, isoprene. vinylbenzocyclobutane, sytrene, alkyl substituted styrene, ethylidene norbornene, dicyelopentadiene and cyclopentene, for example. The formed polymer may include homopolymers, copolymers or terpolymers, for example.

Examples of solution processes are described in U.S. Pat. No. 4,271,060. U.S. Pat. No. 5,001,205, U.S. Pat. No. 5,236,998 and U.S. Pat. No. 5,589,555, which are incorporated by reference herein.

One example of a gas phase polymerization process includes a continuous cycle system, wherein a cycling gas stream (otherwise known as a recycle stream or fluidizing medium) is heated in a reactor by heat of polymerization. The heat is removed from the cycling gas stream in another part of the cycle by a cooling system external to the reactor. The cycling gas stream containing one or more monomers may be continuously cycled through a fluidized bed in the presence of a catalyst under reactive conditions. The cycling gas stream is generally withdrawn from the fluidized bed and recycled back into the reactor. Simultaneously, polymer product may be withdrawn from the reactor and fresh monomer may be added to replace the polymerized monomer. The reactor pressure in a gas phase process may vary from about 100 psig to about 500 psig, or from about 200 psig to about 400 psig or from about 250 psig to about 350 psig, for example. The reactor temperature in a gas phase process may vary from about 30° C. to about I 20° C., or from about 60° C. to about 115° C., or from about 70° C. to about 1 10° C. or from about 70° C. to about 95° C., for example. (See, for example, U.S. Pat. No. 4,543,399; U.S. Pat. No. 4,588,790; U.S. Pat. No. 5,028,670; U.S. Pat. No. 5,317,036; U.S. Pat. No. 5,352,749; U.S. Pat. No. 5,405,922; U.S. Pat. No. 5,436,304; U.S. Pat. No. 5,456,471; U.S. Pat. No. 5,462,999; U.S. Pat. No. 5.616,661; U.S. Pat. No. 5,627,242; U.S. Pat. No. 5.665,818; U.S. Pat. No. 5,677,375 and U.S. Pat. No. 5,668,228, which are incorporated by reference herein.)

Slurry phase processes generally include forming a suspension of solid, particulate polymer in a liquid polymerization medium, to which monomers and optionally hydrogen, along with catalyst, are added. The suspension (which may include diluents) may be intermittently or continuously removed from the reactor where the volatile components can be separated from the polymer and recycled, optionally after a distillation, to the reactor. The liquefied diluent employed in the polymerization medium may include a C₃ to C₇ alkane (e.g., hexane or isobutane), for example. The medium employed is generally liquid under the conditions of polymerization and relatively inert. A bulk phase process is similar to that of a slurry process with the exception that the liquid medium is also the reactant (e.g., monomer) in a bulk. phase process. However, a process may be a bulk process, a slurry process or a bulk slurry process, for example.

In a specific embodiment, a slurry process or a bulk process may. be carried out continuously in one or more loop reactors. The catalyst, as slurry or as a dry free flowing powder, may be injected regularly to the reactor loop, which can itself he filled with circulating slurry of growing polymer particles in a diluent, for example. Optionally, hydrogen may be added to the process, such as for molecular weight control of the resultant polymer. The loop reactor may be maintained at a pressure of from about 27 bar to about 50 bar or from about 35 bar to about 45 bar and a temperature of from about 38° C. to about 121° C., for example. Reaction heat may be removed through the loop wall via any suitable method, such as via a double-jacketed pipe or heat exchanger, for example.

Alternatively, other types of polymerization processes may be used, such as stirred reactors in series, parallel or combinations thereof; for example. In one or more embodiments, the polymerization process includes the production of multi-modal polyolefins. As used herein, the term “multi-modal process” refers to a polymerization process including a plurality of reaction zones (e.g., at least two reaction zones) that produce a polymer exhibiting a multi-modal molecular weight distribution. As used herein, a single composition including a plurality of molecular weight peaks is considered to he a “multi-modal” polyolefin. For example, a single composition including at least one identifiable high molecular weight fraction and at least one identifiable low molecular weight fraction is considered a “bimodal” polyolefin.

The multi-modal polyolefins may be formed via any suitable method, such as via a plurality of reactors in series. The reactors can include any reactors or combination of reactors, as described above. In one or more embodiments, the same catalyst is utilized in the plurality of reactors. In another embodiment, different catalysts are used in the plurality of reactors. In the preparation of bi-modal polymers, the high molecular weight fraction and the low molecular weight fraction can be prepared in any order in the reactors, e.g the low molecular weight fraction may be .formed in the first reactor and the high molecular weight fraction in the second reactor, or vise versa, for example.

Upon removal from the reactor, the polymer may be passed to a polymer recovery system for further processing, such as addition of additives and/or extrusion, for example.

The polymer may be blended with a modifier (i.e., “modification”), which may occur in the polymer recovery system or in another manner known to one skilled in the art. In one or more embodiments, the modifier is a peroxide. For example, the peroxide may include known peroxides, such as benzoyl peroxide, tertiary butyl hydroperoxide, ditertiary butyl peroxide. hydrogen peroxide, potassium persulfate, methyl cyclohexyl peroxide, cumene hydroperoxide, acetyl benzoyl peroxide, tetralin hydroperoxide, phenyleyclohexane hydroperoxide, tertiary butyl peracetate, dimityl peroxide, tertiary butyl perbenzoate, ditertiary amyl perphthalate, ditertiary butyl peradipate, tertiary amyl percarbonate and combinations thereof, for example. In one or more embodiments, the peroxide includes an organic peroxide. For example, the organic peroxides may include Luperox 101, commercially available from Arkoma Inc., Degussa DMBH, commercially available from Degussa Corp., Trigonox® 1010 and Trigonox® 301, both commercially available from Akzo Nobel.

In one or more embodiments, the polymer is blended with the modifier in an amount of up to 50 ppm, or from about 10 ppm to about 30 ppm or from about 15 ppm to about 20 ppm. for example.

The polymer may be blended with the modifier by any suitable method. In addition, the polymer may be blended with the modifier prior to, during or after extrusion of the polymer. In one embodiment, the polymer is blended with the modifier prior to extrusion.

It is contemplated that the polymer may be blended with additional modifiers, such as free radical initiators, including oxygen, for example.

### Polymer Product

The polymers (and blends thereof) formed via the processes described herein may include, but are not limited to, linear low density polyethylene, elastomers, elastomers, high density polyethylenes, low density polyethylenes, medium density polyethylenes, polypropylene and polypropylene copolymers. for example.

Unless otherwise designated herein, all testing methods are the current methods at the time of tiling.

In one or more embodiments, the polymers include ethylene based polymers. As used herein, the term “ethylene based” is used interchangeably with the terms “ethylene polymer” or “polyethylene” and refers to a polymer having at least about 50 wt. %, or at least about 70 wt. %, or at least about 75 wt. %, or at least about 80 wt. %, or at least about 85 wt. % or at least about 90 wt. % polyethylene relative to the total weight of polymer, for example.

The ethylene based polymers may have a density (as measured by ASTM D-792) of from about 0.86 g/cc to about 0.98 g/cc, or from about 0.88 g/cc to about 0.965 g/cc, or from about 0.90 g/cc to about 0.965 g/cc or from about 0.925 g/cc to about 0.97 g/cc, for example.

The ethylene based polymers may have a melt index (MI₂) (as measured by ASTM D-1238) of from about 0.001 dg/min to about 1000 dg/min., or from about 0.01 dg/min. to about 100 dg/min., or from about 0.03 dg/min. to about 10 dg/min, for example.

In one or more embodiments, the polymers include high density polyethylene. As used herein, the term “high density polyethylene” refers to ethylene based polymers having a density of from about 0.94 g/cc to about 0.97 g/cc, for example.

In one or more embodiments, the ethylene based polymer is formed from a Ziegler-Nana catalyst. For example, in one or more specific embodiments, the ethylene based polymer is formed from a Ziegler-Natta catalyst prepared by contact with successively stronger chlorinating agents.

In one or more embodiments, the polymers include high molecular weight polyethylene. As used herein, the term “high molecular weight polyethylene” refers to ethylene based polymers having a molecular weight of from about 50,000 to about 10,000,000, for example.

In one or more embodiments, the ethylene based polymers may exhibit bimodal molecular weight distributions (i.e., they are bimodal polymers). For example, a single composition including two distinct molecular weight peaks using size exclusion chromatograph (SEC) is considered to be a “bimodal” polyolefin. For example, the molecular weight fractions may include a high molecular weight fraction and a low molecular weight fraction.

The high molecular weight fraction exhibits a molecular weight that is greater than the molecular weight of the low molecular weight fraction. The high molecular weight fraction may have a molecular weight of from about 50,000 to about 10,000,000, or from about 60,000 to about 5,000,000 or from about 65,000 to about 1,000,000, for example. In contrast, the low molecular weight fraction may have a molecular Weight of from about 500 to about 50,000. or from about 525 to about 40,000 or from about 600 to about 35,000, for example. 100361 The bimodal polymers may have a ratio of high molecular weight fraction to low molecular weight fraction of from about 80:20 to about 20:80, or from about 70:30 to about 30:70 of from about 60:40 to about 40:60, for example.

In one or more embodiments, the bimodal ethylene based polymer is linear prior to modification. As used herein, the term “linear” refers to polyethylene essentially absent long chain branching. However, the bimodal ethylene based polymer may exhibit long chain branching upon modification. As used herein, the term “long chain branching” refers to branches from the main polymer backbone that are similar in length to the backbone, which may identified as branches having molecular weights at least as great as the critical molecular weight for entanglement (M_{c}) of the polymer.

In one or more embodiments, the bimodal ethylene based polymer exhibits larger rheological breadth after modification. As used herein, “rheological breadth” refers to the breadth of a transition region between Newtonian and power-law type shear rate dependence of the viscosity. The theological breadth is a function of the relaxation time distribution of the polymer and is experimentally determined assuming Cox-Merz rule by fitting flow curves generated using linear-viscoelastic dynamic oscillatory frequency sweep experiments with a modified Carreau-Yasuda (CY) model as follows:

η=η₀[1+(λγ)^{a}]^{(n-1)/a};

wherein η is viscosity (Pa s), γ is shear rate (1/s), a is the rheological breadth parameter, is relaxation time (s), η₀ is zero shear viscosity (Pa s) and n is power law constant.

In one or more embodiments, the bimodal ethylene based polymer exhibits a zero shear viscosity from about 2.5×10⁵ to about 1.0×10⁷ as determined in the same manner described above.

### Product Application

The polymers and blends thereof are useful in applications known to one skilled in the art, such as forming operations (e.g., film, sheet, pipe and fiber extrusion and co-extrusion as well as blow molding, injection molding and rotary molding). Films include blown, oriented or cast films formed by extrusion or co-extrusion or by lamination useful as shrink film, cling film, stretch film, scaling films, oriented films, snack packaging, heavy duty bags, grocery sacks, baked and frozen food packaging, medical packaging, industrial liners, and membranes, for example, in food-contact and non-food contact application. Fibers include slit-films, monotilaments, melt spinning, solution spinning and melt blown fiber operations for use in woven or non-woven form to make sacks, bags, rope, twine, carpet backing, carpet yarns, filters, diaper fabrics, medical garments and geotextiles, for example. Extruded articles include medical tubing, wire and cable coatings, sheet, thermoformed sheet, geomembranes and pond liners, for example. Molded articles include single and multi-layered constructions in the form of bottles, tanks, large hollow articles, rigid food containers and toys, for example.

In one or more embodiments, the polymers are utilized to form pipe articles. For example, the pipe articles may include pipe, tubing, molded fittings, pipe coatings and combinations therefore. The pipe articles may be utilized in industrial/chemical processes, mining operations, gas distribution, potable water distribution, gas and oil production, fiber optic conduit, sewer systems and pipe relining, for example. In one embodiment, a thick walled pipe capable of withstanding high pressure is provided.

Prior efforts to improve properties of pipe articles have included utilizing ethylene based polymers, and limited use of bimodal ethylene based polymers. However, sag resistance is an important performance characteristic of polyethylene that heretofore has been unattainable with bimOdal ethylene based polymers. Forming pipe articles from the bimodal polyethylene described herein generally requires significant cooling time. During the cooling process, the pipe article is generally arranged having a substantially horizontally aligned longitudinal axis wherein the pipe wall can sag during cooling. This sag causes a lower wall portion of the pipe to attain a greater thickness than an upper wall portion. Excess sag in pipe articles decrease pipe performance (e.g., thinner sections are weaker), resulting in processing difficulties and/or hindering the fluid flow there through, for example. Therefore, sag resistance is an important feature in pipe article formation and selection of polymer used to form the pipe article. In particular, sag resistance in thick walled pipe has been particular difficult with bimodal ethylene based polymers.

In one or more embodiment, the pipe articles may have a wall thickness at least about 1 inch, or at least about 1.25 inches or at least about 1.5 inches, for example. In another embodiment, the polymers are utilized to form thermoformed articles or corrugated sheets, for example.

In one or more embodiments, the pipe articles have a large diameter (e.g., a diameter of at least about 42 inches or from 42 inches to about 72 inches).

A theological method is used to determine sag resistance. This method, which is used in connection with the present invention, relates to the rheology of the polymer and is based on determination of the viscosity of the polymer at a very low, constant shear stress. A. shear stress of 747 Pa has been selected for this method. The viscosity of the. polymer at this shear stress is determined at a temperature of 190° C. and has been found to be inversely proportional to the gravity flow of the polymer, i.e., the greater the viscosity the lower the gravity flow. At the present invention the viscosity at 747 Pa and 190° C. should be at least 650 kPa.s. A more detailed description of the steps of the method for determination of the viscosity of the polymer . at 747 Pa and 190° C. is given below.

The determination is made by using a rheometer, such as a Bohlin CS Melt Rheometer. Rheometers and their function have been described in “Encyclopedia of Polymer Science and Engineering”, 2nd Ed., Vol. 14, pp. 492-509. The measurements are performed under a constant stress between two 25 mm diameter plates (constant rotation direction). The gap between the plates is 1.8 mm. An 1.8 mm thick polymer sample is inserted between the plates.

It has been found that when the polymer has been prepared to have the above-mentioned characteristics, the resulting material has low tendency for sagging. It also has superior extrudability and mechanical properties.

### EXAMPLES

As used herein, Polymer “A” was a bimodal high density polyethylene pipe grade, commercially available from Dow Chemicals.

As used herein. Polymer “B” was a bimodal high density polyethylene pipe grade from Ineos.

As used herein, Polymer “C” was a bimodal high density polyethylene pipe grade commercially available from TOTAL PETROCHEMICALS USA, Inc.

As used herein. Polymer “D” was a bimodal high density polyethylene from TOTAL PETROCHEMICALS USA, inc modified with 20 ppm of modifier

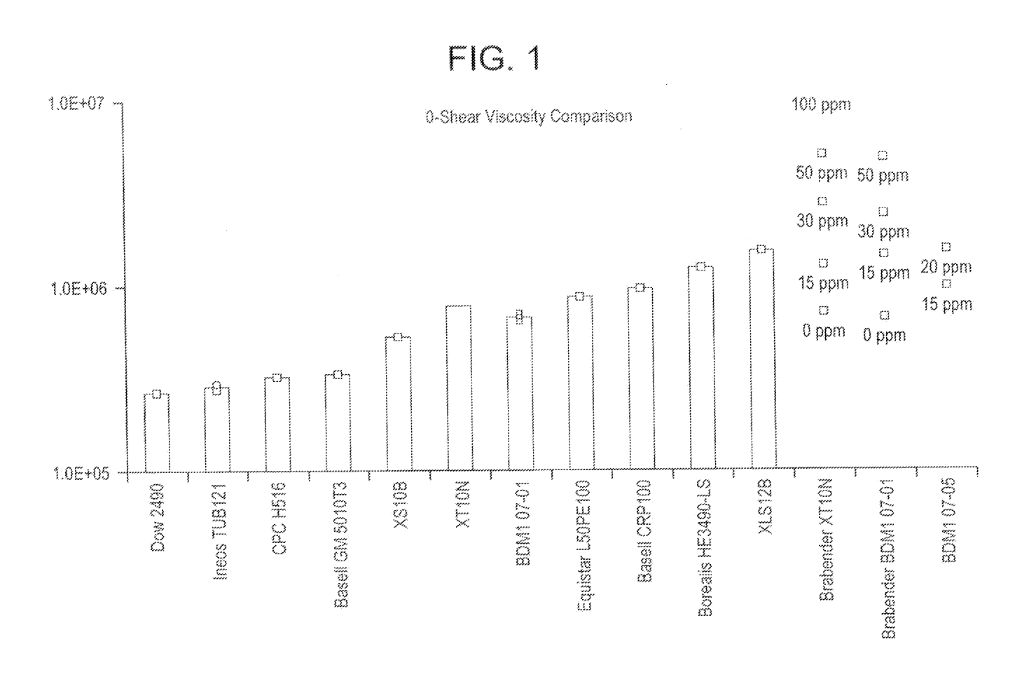

FIG. 1 illustrates commercial HDPEs and the increase in zero shear viscosity of the modified HDPE (Polymer D).

While the foregoing is directed to embodiments of the present invention, other and further embodiments of the invention may be devised without departing from the basic scope thereof and the scope thereof is determined by the claims that follow.

What is claimed is:

1. A method of forming a pipe article comprising:
providing a bimodal ethylene based polymer;
blending the bimodal ethylene based polymer with up to about 50 ppm peroxide to form modified polyethylene;
forming the modified polyethylene into a pipe.

2. The method of claim 1, wherein the bimodal ethylene based polymer is formed from a Ziegler-Natta catalyst system, wherein the Ziegler-Natta catalyst system is formed by contacting an alkyl magnesium compound with an alcohol to form a magnesium dialkoxide compound and contacting the magnesium dialkoxide compound with successively stronger chlorinating agents.

3. The method of claim 1, wherein the modified polyethylene comprises from about 10 ppm to 30 ppm peroxide.

4. The method of claim 1, wherein peroxide comprises an organic peroxide.

5. The method of claim 1, wherein the modified polyethylene exhibits a rheological breadth parameter “a” that is increased over an “a” parameter of the bimodal ethylene based polymer.

6. The method of claim 1, wherein the modified polyethylene exhibits a rheological breadth parameter “a” of from about 0.19 to about 0.21.

7. The method of claim 1, wherein the modified polyethylene exhibits a relaxation time of from about 0.8 to about 7 seconds.

8. The method of claim 1, wherein the modified polyethylene exhibits a zero shear viscosity of from about 2.5*10⁵ Pa s to about 1.0*10⁷ Pa s.

9. The method of claim 1, wherein the bimodal ethylene based polymer is linear and the modified polyethylene exhibits long chain branching.

10. The method of claim 1 further comprising blending the bimodal ethylene based polymer with a free radical initiator.

11. The method of claim 10, wherein the free radical initiator comprises oxygen.

12. The method of claim 1, wherein the bimodal ethylene based polymer comprises high density polyethylene.

13. The method of claim 1, wherein the bimodal ethylene based polymer comprises high molecular weight polyethylene, the high molecular weight polyethylene exhibiting an Mw of from about 50.000 to about 10,000,000.

14. A pipe article formed by the method of claim 1.

15. The pipe article of claim 14, wherein the pipe article comprises a wall thickness of at least about 1.25 inches.

16. The pipe article of claim 14, wherein the pipe article comprises a diameter of at least 42 inches.
